(19) United States
(12) Patent Application Publication
(10) Pub. No.: US 2011/0155746 A1
(43) Pub. Date: Jun. 30, 2011

(54) ANIMAL-SHAPED TRASH RECEPTACLE WITH CAVITY HAVING TRANSPARENT VIEWING WINDOW

(76) Inventor: Mark Armen, Santa Monica, CA (US)

(21) Appl. No.: 12/968,619

(22) Filed: Dec. 15, 2010

Related U.S. Application Data
(60) Provisional application No. 61/290,502, filed on Dec. 29, 2009.

(51) Int. Cl. B65D 25/54; B23P 17/04

(52) U.S. Cl. 220/662; 29/428

(57) ABSTRACT

An animal-shaped trash receptacle is described. The trash receptacle is formed in an animal shape to include at least a torso section of the animal. The torso section includes a cavity for accumulating trash. A transparent viewing window is affixed with the torso section for allowing an individual to view the trash accumulated in the torso section. Additionally, a measurement gauge is affixed with the transparent viewing window to represent a volume of trash with a holding capacity of a particular stomach.

### PRIORITY CLAIM

This is a non-provisional application of U.S. Provisional Application No. 61/290,502, filed on Dec. 29, 2009, entitled, “Animal-shaped trash receptacle with cavity having translucent viewing window.”

### BACKGROUND OF THE INVENTION

(1) Field of Invention

The present invention relates to a trash receptacle and, more particularly, to an animal-shaped trash receptacle with a cavity having a transparent viewing window for viewing the contents therein.

(2) Description of Related Art

Despite major strides in the last forty years, litter remains to be a key problem, with negative economic, social, and environmental effects. According to a major nationwide study, 51.2 billion pieces of litter were found on roadways (or 6,729 pieces of litter per mile, on each side); of this litter, 91% was less than four inches in size. See National Visible Litter Survey and Litter Cost Study, 2009, Keep American Beautiful, Inc. Notably, general litter along roadways has reduced 61% since 1969; however, plastic litter has increased 165%.

This increase in plastic litter, predominately under 4 inches in size, poses a major risk to wildlife survival, water quality, and food supply integrity. Such small litter finds its way to lakes and oceans via rivers, waterways, and urban drains after slipping through urban runoff systems. Once in a water environment, the litter mimics food and gets swallowed by marine life and/or leaches and attracts toxic chemicals, in the end contaminating the human food supply.

To solve the problem of general litter, trashcans have been placed along roadways. The nationwide study (mentioned above) indicates that 91% of the researched locations had a general trashcan. For plastic waste, in particular, recycling has been deemed the solution (although only 12% of the research locations had adjacent recycling containers). Non-infrastructural activities, such as educational campaigns and cleanup activities have been and are promoted.

To solve the problem that litter poses to wildlife survival, water quality, and human health, some municipalities have installed urban catchment devices to prevent litter from entering waterways, lakes, and oceans. On an educational level, vivid photos of dead animals with stomachs full of small plastics have been circulated to the public (although such communication has been very minimal).

There still exists a need to address litter, particularly small litter less than 4 inches in size. In addition to the numbers previously mentioned, beach cleanup numbers continuously reveal a huge need to address litter that makes it way to the marine environment.

The first study mentioned above uncovered that littering is 85% personally motivated, and 15% is contextual (or situational)—and thus recommends installing more trash and ash receptacles at shorter distances from each other. The study further segregated cigarette butt litter as 62% personally motivated, and 38% contextual. In fact, 38% of all litter was from tobacco products (mainly cigarette butts) and the study shows that the littering rate of cigarette butts decreased by 9% for every added trash/ash receptacle.

Importantly, there exists a major need to communicate the connection between litter and the risk it poses to wildlife survival, water quality, and human health. While trash and ash receptacles address the 15% contextual aspects of littering, individual level messaging and activities that communicate a “personal obligation not to litter are important for targeting the motivational side of the equation.” Thus, a continuing need exists for trash receptacles that are proximate usage sites (satisfying the contextual need) and that can relate the impact of the trash to wildlife, water quality, and human health (satisfying the personally motivated need).

### SUMMARY OF INVENTION

While considering the failure of others to make use of all of the above components in this technology space, the inventor unexpectedly realized that an animal-shaped trash receptacle could operate as a trash receptacle while communicating the connection between litter and the risk it poses to wildlife.

The trash receptacle is formed in an animal shape. As a non-limiting example, the trash receptacle can be formed to include the head and/or the torso section of an animal. The torso section includes a cavity for accumulating trash. A transparent viewing window is affixed with the torso section for allowing an individual to view the trash accumulated in the torso section. Additionally, a measurement gauge is affixed with or near the transparent viewing window. The measurement gauge can be used to represent a number of things. For example, the gauge can represent a volume of trash with a holding capacity of a particular stomach. As another example, it can represent the number of lives (e.g., fish) saved based on a corresponding volume of trash positioned within the receptacle.

In another aspect, the trash receptacle includes an outer container and an inner container which serves as the cavity. The outer container includes an outer trash insert and the inner container includes an inner trash insert, such that when the inner container is positioned within the outer container, the inner trash insert is aligned with the outer trash insert, thereby allowing a user to position trash through the inserts and into the cavity.

In yet another aspect, a grate is attached with the inner container and positioned such that when the inner container is positioned within the outer container, the grate and inner trash insert are both aligned with the outer trash insert.

In yet another aspect, a sound system can be included. In this aspect, the sound system is attached with the receptacle and is operable for detecting the insertion of trash in the receptacle and emitting a predetermined sound.

Further, a light is positioned within the receptacle to illuminate trash accumulated therein.

Finally, as can be appreciated by one in the art, the present invention also comprises a method for forming and using the receptacle described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a front, perspective-view illustration of a trash receptacle according to the present invention;

FIG. 2 is a front, perspective-view illustration of a trash receptacle according to the present invention, depicting the trash receptacle as having an inner canister and an outer shell;

FIG. 3 is a rear, perspective-view illustration of the trash receptacle, with the canister positioned within the outer shell; and

FIG. 4 is an illustration of another trash receptacle according to the present invention.

### DETAILED DESCRIPTION

The present invention relates to a trash receptacle and, more particularly, to an animal-shaped trash receptacle with a cavity having a translucent viewing window. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

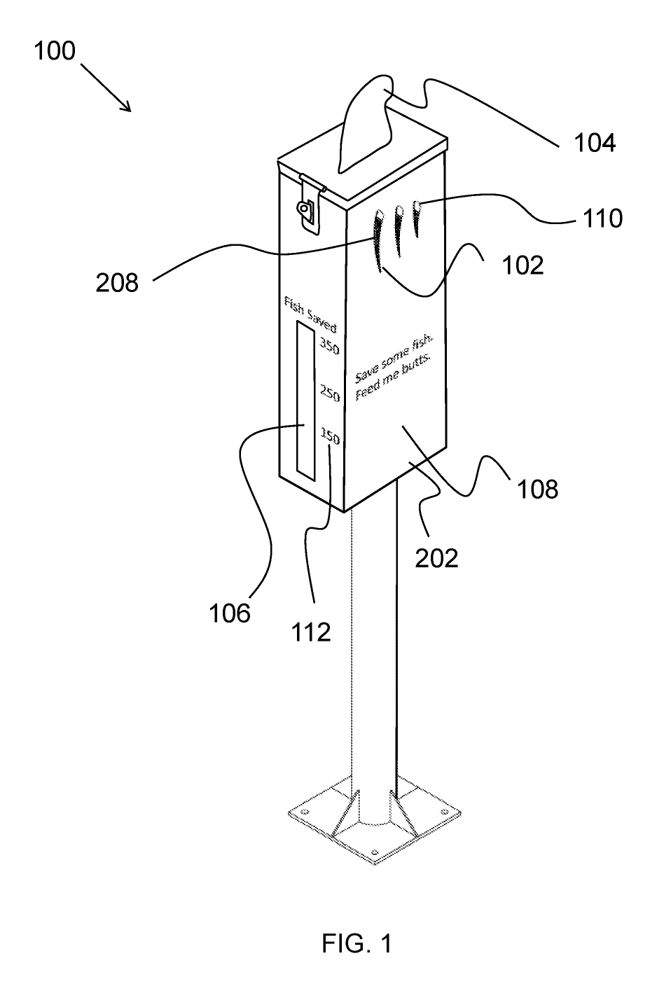

As shown in FIG. 1, the present invention relates to a modified trash receptacle 100 (or trash and ash receptacle) that addresses the prevalence of small litter (e.g., under 4 inches in size) and communicates the litter connection to the impact on wildlife and human survival.

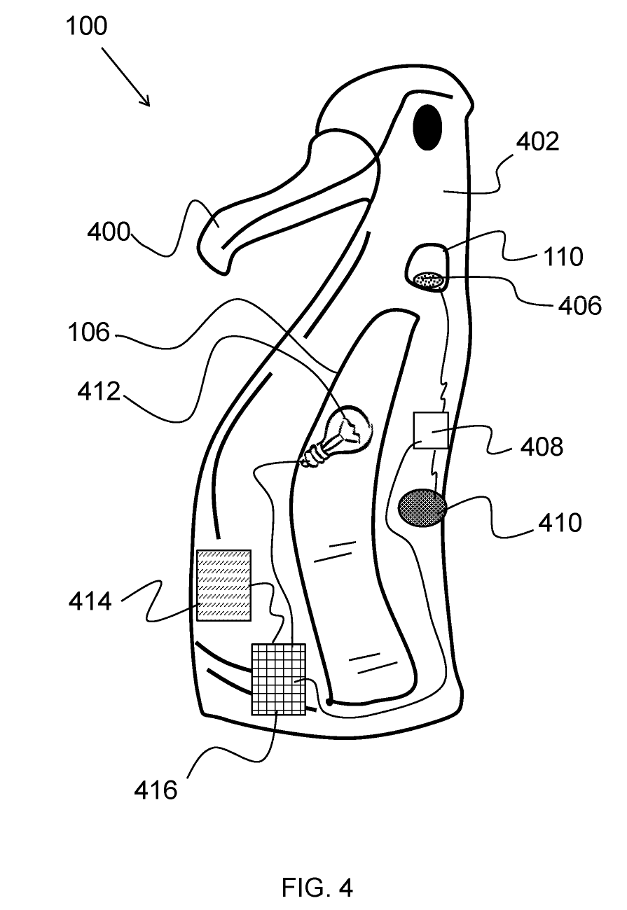

More specifically, the present invention is an animal-shaped trash receptacle 100 that includes at least one recognizable animal feature that assists the public in identifying the trash receptacle 100 as being animal-shaped and representing an animal. As a non-limiting example, the trash receptacle 100 can include gills 102 and a fin 104 (e.g., such as shark gills and a shark fin). As depicted in FIG. 4 and as another non-limiting example, the trash receptacle 100 can be formed in the shape of a bird and include a bird's beak 400. Thus, as can be appreciated by one skilled in the art, there are numerous shapes and recognizable features that can be incorporated into the trash receptacle 100 to assist the public in identifying the trash receptacle 100 as representing an animal.

Further, to assist the public in associating the trash with its effect on wildlife, etc., the trash receptacle 100 can be formed with a transparent viewing window 106 to reveal the trash contained inside. For example, a portion of the trash receptacle 100 can be formed to represent a torso section 108 of a particular animal. As depicted in FIG. 1, the torso section 108 would be the stomach portion of a fish, with the gills 102 and fin 104 further reinforcing the depiction of a fish. Thus, while trash can be deposited within the torso section 108 (which includes a cavity for accumulating trash), the viewing window 106 reveals trash contained inside to draw a connection as to where litter goes if not reduced and/or not placed in appropriate bins. The transparent viewing window 106 is formed of any translucent or transparent material, non-limiting examples of which include plastic and glass.

The animal-shaped trash receptacle 100 can also include a head for purely aesthetic purposes (depicted in FIG. 4 as element 402). Alternatively, the head can be used as an opening to the cavity of the trash receptacle 100 for insertion of the trash. In yet another aspect, the head can include an openable mouth that provides access to the cavity. Thus, the openable mouth or opening both serve as trash inserts through which trash can be inserted into the trash receptacle 100. As a non-limiting example and as depicted in FIG. 1, an outer trash insert 110 can be a cut-out in the side of the container, with the cut-out forming the gills 102.

In some cases, the outer trash insert 110 will be placed in the neck region to simulate the process of wildlife eating human trash. Alternatively and as described above, the outer trash insert 110 can be positioned where the gills 102 are located (in the example of a fish).

In addition, a measurement gauge 112 can be provided near the transparent viewing window 106. The measurement gauge 112 can include markings or other indicia (e.g., that is printed on the receptacle 100) that provides some equitable relevance to the amount of trash positioned within the trash receptacle 100. As a non-limiting example, the measurement gauge includes markings or indicia to equate the amount of trash in the trash receptacle 100 to the holding capacity of a particular stomach. As another example, the measurement gauge 112 can be used to equate the amount of wildlife saved per the volume of trash collected in the trash receptacle 100. For example and as depicted in FIG. 1, if the trash receptacle 100 is being used as a cigarette receptacle, then the volume of cigarettes that reach a particular marking on the measurement gauge 112 can be used to indicate how many fish lives are saved by not allowing that volume of trash to be dispensed into the ocean. These markings can be purely symbolic or factual as can be supported by various research studies.

In another aspect and as shown in FIG. 4, the trash receptacle 100 can be include a sound system that formed to play sound upon insertion of trash or other items. As a non-limiting example, the trash receptacle 100 will play a sound of an animal (or other appropriate sound) when trash is inserted into the receptacle 100. Additionally, the receptacle can be formed to play a sound after a period of time where no trash has been inserted therein. In both aspects, the sound system includes a suitable sensor 406 (e.g., light sensor or switch mechanism) that is connected with or near the outer trash insert 110 so that insertion of trash (or absence thereof) triggers the sensor 406. In either event, the sound system also includes a sound chip 408 and audio transmission device (e.g., speakers 410) that are communicatively connected with the sensor 406 to so that upon receiving the suitable command, the sound chip 408 begins to play the sound through the speakers 410.

Also as shown in FIG. 4, the trash receptacle 100 can be formed to include a back light 412 for night time illumination and attraction. For example, during the evening, in order to attract trash and continue to communicate the stomach contents connection, a back light 412 will be inserted within the trash receptacle 100. The back light 412 can positioned within the cavity of the trash receptacle 100 and timed to turn on to illuminate its contents through the viewing window 106. As can be appreciated by one skilled in the art, the light 412 can be turned on using any suitable mechanism or device, non-limiting examples of which include a time or light sensor (e.g., which turns on the light from dusk until dawn).

In the event that the trash receptacle 100 includes electrical components (e.g., sound, light, timers, sensors, etc.), such components will need a power source. The trash receptacle 100 can be hardwired into an electrical supply or, alternatively, include a solar power unit 414 that charges a battery 416 to power the items.

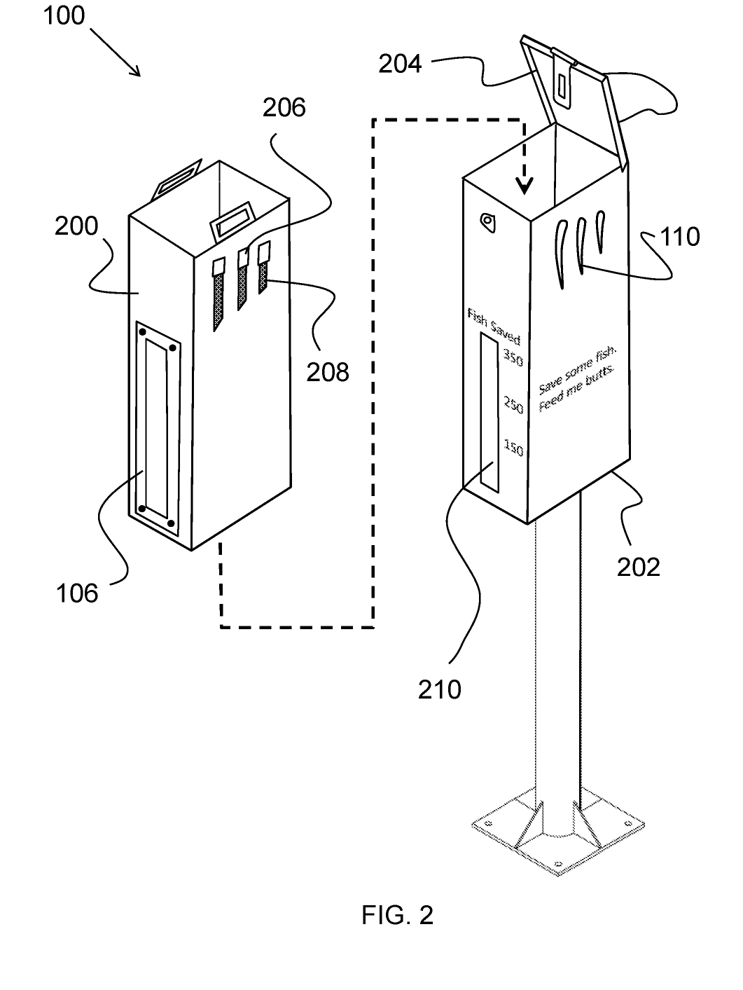

As can be appreciated, a fixed trash receptacle can be difficult to empty and clean. In this case, the trash receptacle 100 can be secured to a sidewalk, etc. As such, the present invention is designed to assist municipalities or other users to easily empty and clean the trash receptacle 100. Referring again to FIG. 2, the trash receptacle 100 is formed to include an inner container 200 and an outer container 202. The inner container 200 is formed to fit within the outer container 202 and collect trash dispensed therein. To clean or empty the trash receptacle 100, a hingedly connected lid 204 or other containment mechanism can be moved to allow a user to remove the inner container 200 for emptying. As can be appreciated by one skilled in the art, it is not necessary that the inner container 200 be removable in its entirety, as it could be hingedly attached and dumped by accessing a back panel or door. Further, it should be noted that the present invention is not limited to having both an inner 200 and outer 202 container and can be formed as a single container within the scope of the present invention. For example, a single container is operable for collecting trash and can be easily formed with all or some of the other elements described herein.

As noted above, the trash receptacle 100 can be formed to include an outer trash insert 110 in a particular shape, such as gills. For example, the outer trash insert 110 can be cut as an opening through the outer container 202. The inner container 200 can be formed with a corresponding inner trash insert 206 such that when the inner container 200 is positioned within the outer container 202, the outer trash insert 110 is aligned with the inner trash insert 206 to allow trash to be positioned through both inserts 110 and 206 and deposited within the cavity that is the inner container 200.

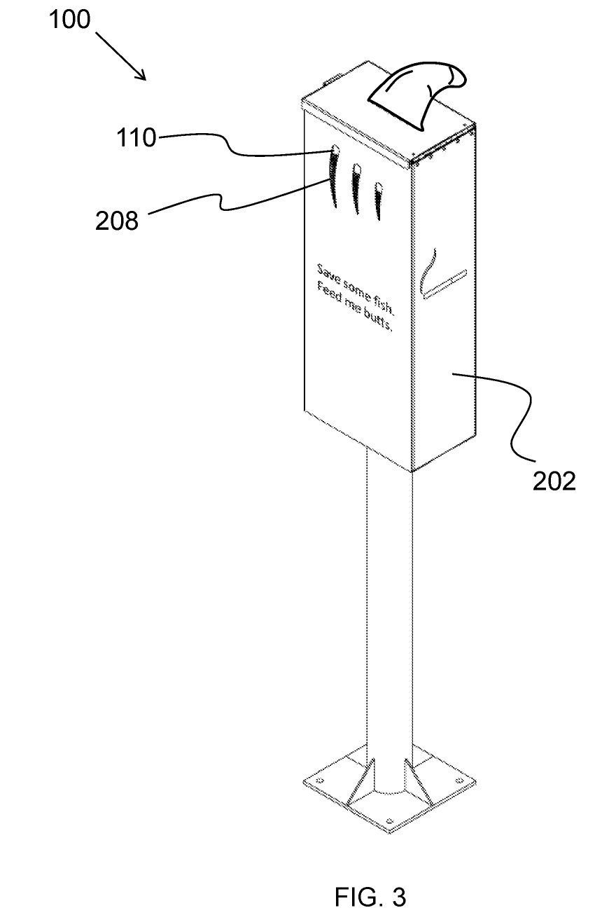

To control the size of the trash that is deposited within the trash receptacle 100, the trash inserts 110 and 206 can be formed of any desired size. As a non-limiting example, the trash inserts can be formed to be approximately one half inch in size, which allows for an ideal size for cigarette collection. As another non-limiting example, a grate 208 (or wire mesh) can be used to snuff out the cigarette and limit the hole size and what people can fit into it. As a non-limiting example, a grate 208 can be attached with the inner container 200 such that when the inner container 200 is positioned within the outer container 202, it allows access to the grate 208 through the outer trash insert 110, yet still allows for deposition of the trash through both the outer trash insert 110 and the inner insert 206. For example, both FIGS. 1 and 3 illustrate the inner container as positioned within the outer container 202, with the grate 208 aligned with the outer trash insert 110. Alternatively, the grate 208 can be affixed directly with the outer container 202.

Referring again to FIG. 2, the illustration depicts the viewing window 106 as being a transparent material (e.g., plexiglass) affixed (e.g., via screws or other suitable connection technique) with the inner container 200 over a hole or opening in the inner container 200. Thus, in this aspect, the outer container 202 includes a viewing cutout 210 that is formed to align with the viewing window 106 when the inner container 200 is positioned within the outer container 202. Again, this viewing window 106 allows the public or users to identify the contents of the trash receptacle 100.

In summary, several studies have shown that littering rates decrease as the convenience of using a proper trash or ash receptacle increases. More trash cans reduce litter and tobacco-related litter. Most importantly, research indicates that the “salience of the receptacle can also decrease litter rates. A brightly colored, themed, or decorated receptacle attracts considerably more trash than does a plain or ordinary appearing receptacle.” Thus, the design, shape, colors, sound, and lights of the present invention will not only address the personable responsibility of not littering (i.e., the connection between littering and its effects on animals and humans), it will also attract more trash on a contextual, infrastructural level.

What is claimed is:

1. An animal-shaped trash receptacle, comprising:
a trash receptacle formed in an animal shape and formed to include a torso section of the animal;
the torso section having a cavity for accumulating trash; and
a transparent viewing window affixed with the torso section for allowing an individual to view the trash accumulated in the torso section.

2. The animal-shaped trash receptacle as set forth in claim 1, further comprising a measurement gauge attached with the trash receptacle to allow for measurement of trash accumulated in the torso section as viewed through the viewing window.

3. The animal-shaped trash receptacle as set forth in claim 2, wherein the trash receptacle includes an outer container and an inner container which serves as the cavity, the outer container having an outer trash insert and the inner container having an inner trash insert, such that when the inner container is positioned within the outer container, the inner trash insert is aligned with the outer trash insert, thereby allowing a user to position trash through the inserts and into the cavity.

4. The animal-shaped trash receptacle as set forth in claim 3, further comprising a grate attached with the inner container and positioned such that when the inner container is positioned within the outer container, the grate and inner trash insert are both aligned with the outer trash insert.

5. The animal-shaped trash receptacle as set forth in claim 4, wherein the measurement gauge includes indicia to represent wildlife saved per a corresponding volume of trash collected in the trash receptacle.

6. The animal-shaped trash receptacle as set forth in claim 5, further comprising a sound system attached with the receptacle, the sound system being operable for detecting the insertion of trash in the receptacle and emitting a predetermined sound.

7. The animal-shaped trash receptacle as set forth in claim 6, further comprising a light positioned within the receptacle to illuminate trash accumulated therein.

8. The animal-shaped trash receptacle as set forth in claim 2, wherein the measurement gauge includes indicia to represent wildlife saved per a corresponding volume of trash collected in the trash receptacle.

9. The animal-shaped trash receptacle as set forth in claim 1, further comprising a sound system attached with the receptacle, the sound system being operable for detecting the insertion of trash in the receptacle and emitting a predetermined sound.

10. The animal-shaped trash receptacle as set forth in claim 1, further comprising a light positioned within the receptacle to illuminate trash accumulated therein.

11. An animal-shaped trash receptacle, comprising:
a trash receptacle formed in an animal shape and formed to include a torso section of the animal;
the torso section having a cavity for accumulating trash;
a transparent viewing window affixed with the torso section for allowing an individual to view the trash accumulated in the torso section; and
wherein the trash receptacle includes an outer container and an inner container which serves as the cavity, the outer container having an outer trash insert and the inner container having an inner trash insert, such that when the inner container is positioned within the outer container, the inner trash insert is aligned with the outer trash insert, thereby allowing a user to position trash through the inserts and into the cavity; and
a grate attached with the inner container and positioned such that when the inner container is positioned within the outer container, the grate and inner trash insert are both aligned with the outer trash insert.

12. The method for forming an animal-shaped trash receptacle, comprising acts of:
forming a trash receptacle in an animal shape to include a torso section of the animal, where the torso section includes a cavity for accumulating trash;
affixing a transparent viewing window with the torso section for allowing an individual to view the trash accumulated in the torso section; and
affixing a measurement gauge with the transparent viewing window to represent a volume of trash with a holding capacity of a particular stomach.
